(19) United States
(12) Patent Application Publication
(10) Pub. No.: US 2024/0411332 A1
(43) Pub. Date: Dec. 12, 2024

(54) POWER MANAGEMENT SYSTEM FOR DEVICE-SPECIFIC OPTIMIZATION

(71) Applicant: LifeSafety Powe, LLC, Libertyville, IL (US)

(72) Inventors: Baruch Spence, Phoenix, AZ (US); Kevin Ture, Phoenix, AZ (US); Benjamin Williams, New Haven, CT (US)

(21) Appl. No.: 18/734,939

(22) Filed: Jun. 5, 2024

Related U.S. Application Data
(60) Provisional application No. 63/506,572, filed on Jun. 6, 2023.

(51) Int. Cl. G05F 1/565; G06F 8/71; G06F 21/44; G06F 21/64

(52) U.S. Cl. CPC G05F 1/565; G06F 8/71; G06F 21/44; G06F 21/64

(57) ABSTRACT

Described herein is a power management system that optimizes its operation based on devices that are being powered by the power management system. The power management system communicates with one or more devices through a network to obtain authentication information (e.g., digital certificates) from the device(s). The power management system uses the authentication information to determine an identity (e.g., manufacturer name, model number, firmware version, and/or manufacturing date) of each of the device(s). The power management system configures its operation based on the determined identities of the device(s).

### RELATED APPLICATIONS

This application is a Non-Provisional of Provisional (35 USC 119 (e)) of U.S. Application Ser. No. 63/506,572, filed Jun. 6, 2023, entitled “POWER MANAGEMENT SYSTEM FOR DEVICE-SPECIFIC OPTIMIZATION,” which is herein incorporated by reference in its entirety.

### RELATE FIELD

Described herein is a power management system that optimizes its operation for particular devices (e.g., electronic locks) powered by the power management system. The power management system communicates with the device(s), recognizes the identities of the device(s), and optimizes operation based on the identities of the device(s).

### BACKGROUND

Power management systems supply electrical power for use by various devices. The power management system may include a power supply that outputs power. For example, the power supply may output power to electrical devices, such as electric locks. A power management system may include mechanisms of fault detection and reporting. The power management system may include fault response functionality and visual indicators (e.g. LED lights) of detected faults (e.g., power loss).

### BRIEF SUMMARY

Described herein is a power management system that optimizes its operation based on devices that are being powered by the power management system. The power management system communicates with one or more devices through a network to obtain authentication information (e.g., digital certificates) from the device(s). The power management system uses the authentication information to determine an identity (e.g., manufacturer name, model number, firmware version, and/or manufacturing date) of each of the device(s). The power management system configures its operation based on the determined identities of the device(s).

According to one aspect, a power management system is provided. The power management system customizes operation for devices being powered by the power management system. The power management system includes a power supply electrically coupled to at least one device, the at least one device including a first device. The system includes a control system configured to control operation of the power supply. The control system comprises a processor, and memory configured to store a first device profile storing electrical characteristics of the first device. The control system is configured to use the processor to: determine an identity of the first device electrically coupled to the power supply; access, from the memory, the first device profile storing electrical characteristics of the first device; and control transmission of electricity from the power supply to the first device based on the electrical characteristics of the first device.

In some embodiments, controlling the transmission of electricity from the power supply to the first device based on the electrical characteristics of the first device comprises: modulating a voltage output to the first device. In some embodiments, the electrical characteristics of the first device comprises a voltage range of operation for the first device, and modulating the voltage output to the first device comprises modulating the voltage to remain within the voltage range of operation.

In some embodiments, the device profile further stores one or more of an identifier of a manufacturer of the first device, a model of the first device, and a firmware version of software installed on the first device.

In some embodiments, the power management system further comprises: a wireless communication device, wherein the control system is configured to use the processor to: communicate with at least one sensor using the wireless communication device; and control transmission of electricity from the power supply to the first device based on information obtained from the at least one sensor.

In some embodiments, the power management system includes the first device, wherein the first device is an electronic lock. In some embodiments, the power management system includes the first device, wherein: the first device includes a chipset; and determining the identity of the first device comprises obtaining authentication information from the chipset of the first device. In some embodiments, the authentication information obtained from the first device comprises a digital certificate provided by the first device.

In some embodiments, the at least one device includes a second device different from the first device; the memory is configured to store a second device profile storing electrical characteristics of the second device; and the control system is configured to use the processor to: determine an identity of the second device electrically coupled to the power supply; access, from the memory, the second device profile storing electrical characteristics of the second device; and control transmission of electricity from the power supply to the second device based on the electrical characteristics of the second device.

In some embodiments, the control system is further configured to use the processor to: access, from a computer system associated with an energy provider, energy cost information; and determine an energy cost of operating the first device during a time period.

According to another aspect, a method of customizing operation of a power management system for devices being powered by the power management system is provided. The power management system comprises a power supply electrically coupled to at least one device. The method comprises: using a processor to perform determining an identity of a first device of the at least one device electrically coupled to the power supply; accessing, from memory of the power management system, a first device profile storing electrical characteristics of the first device; and controlling transmission of electricity from the power supply to the first device based on the electrical characteristics of the first device.

In some embodiments, controlling the transmission of electricity from the power supply to the first device based on the electrical characteristics of the first device comprises: modulating a voltage output to the first device. In some embodiments, the electrical characteristics of the first device comprises a voltage range of operation for the first device, and modulating the voltage output to the first device comprises modulating the voltage to remain within the voltage range of operation.

In some embodiments, the device profile further stores one or more of an identifier of a manufacturer of the first device, a model of the first device, and a firmware version of software installed on the first device.

In some embodiments, the method further comprises: communicating, using a wireless communication device, with at least one sensor; and controlling transmission of electricity from the power supply to the first device based on information obtained from the at least one sensor.

In some embodiments, the first device is an electronic lock. In some embodiments, the first device includes a chipset; and determining the identity of the first device comprises obtaining authentication information from the chipset of the first device. In some embodiments, the authentication information obtained from the first device comprises a digital certificate provided by the first device.

In some embodiments, the at least one device includes a second device different from the first device and the method further comprises: determining an identity of the second device electrically coupled to the power supply; accessing, from the memory, a second device profile storing electrical characteristics of the second device; and controlling transmission of electricity from the power supply to the second device based on the electrical characteristics of the second device.

According to another aspect, a non-transitory computer-readable medium storing instructions is provided. The instructions, when executed by a processor, cause the processor to perform a method of customizing operation of a power management system for devices being powered by the power management system. The power management system comprises a power supply electrically coupled to at least one device. The method comprises: determining an identity of a first device of the at least one device electrically coupled to the power supply; accessing, from memory of the power management system, a first device profile storing electrical characteristics of the first device; and controlling transmission of electricity from the power supply to the first device based on the electrical characteristics of the first device.

The foregoing summary is non-limiting.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A is an example environment including a power management system, according to some embodiments of the technology described herein.

FIG. 1B shows components of a control system of the power management system of FIG. 1A, according to some embodiments of the technology described herein.

FIG. 1C shows example device information that may be stored in a datastore of the control system of FIGS. 1A-1B, according to some embodiments of the technology described herein.

FIG. 2 is an example power supply, according to some embodiments of the technology described herein.

FIG. 3 is an example process for optimizing operation of devices powered by a power management system, according to some embodiments of the technology described herein.

FIG. 4 is an example process for optimizing a power supply for a device based on an identity of the device, according to some embodiments of the technology described herein.

FIG. 5 is an example process of optimizing energy management for a device, according to some embodiments of the technology described herein.

FIG. 6 is an example computer system that may be used to implement some embodiments of the technology described herein.

### DETAILED DESCRIPTION

Described herein is a power management system that configures its operation according to the identities of devices being powered by the power management system.

A power management system may manage distribution of electrical power at a location (e.g., a building, a home, or other type of location). The power management system may supply power to various devices. For example, the power management system may supply power to electric locks in a building.

The inventors have recognized that conventional power management systems operate without accounting for the devices that are powered by the power management system. As such, conventional power management systems may not operate effectively or efficiently for the devices. For example, the response of a power management system to a fault or failure condition in its power supply may be detrimental to a device being powered by the power management system. As another example, a voltage being output to a device may be outside of the device's required or optimal voltage operation range.

The inventors have recognized that a control system integrated into a power management system can be used to optimize operation of the power management system for devices being powered by the power management system. Accordingly, the inventors have developed a control system that determines the identities of devices being powered by the power management system and configures the power management system based on the device identities. The operation of the power management system may be optimized for the devices. The power management system may control the output of electricity from a power supply of the power management system to the devices in a manner customized for the device. For example, the power management system may module voltage output to a device based on the electrical characteristics (e.g., a voltage operation range) of the device. As another example, the control system may cause the power management system to respond to fault or failure conditions in a manner that protects the hardware of the devices.

In some embodiments, the control system may comprise of a computer system integrated into the power management system. The control system may communicate with devices being powered by the power management system. For example, the control system may comprise a server integrated into the power management system that can communicate with the devices powered by the power management system (e.g., through the power connection). The control system may obtain information from the devices and use the information to determine identities of the devices. The control system may configure operation of the power management system based on the determined device identities.

For example, the control system may establish a communication channel (e.g., an encrypted connection) with an electronic lock being powered by the power management system, and obtain authentication information (e.g., a digital certificate) from the device through the communication channel. The control system may use the authentication information to determine a device identity. For example, the control system may determine the electrical characteristics of the electronic lock (e.g., a voltage range that the electronic lock operates with), a manufacturer name, a model number, a firmware version, and/or a manufacturing date of the electronic lock. The control system may use the device identity to configure the operation of the power management system. For example, the control system may control the transmission of electricity from a power supply to the electronic lock based on its electrical characteristics.

In some embodiments, a control system of a power management system may store operational parameters for controlling a power supply of the power management system. The control system may configure operation of the power management using a device identity by configuring the operational parameters for controlling the power supply. The control system may configure the operational parameters by: (1) determining values of one or more of the operational parameters based on the device identity; and (2) setting the operational parameters to the determined values. The operational parameters may be used in controlling operation of the power supply. For example, the operational parameters may control a response of the power supply to fault or failure conditions. As another example, the operational parameters may control power output by the power supply.

Example embodiments may be described herein using an electronic lock as an example device that is being powered by a power management system. An electronic lock is an example device used herein for illustrative purposes. Some embodiments may use different devices instead of or in addition to electronic locks.

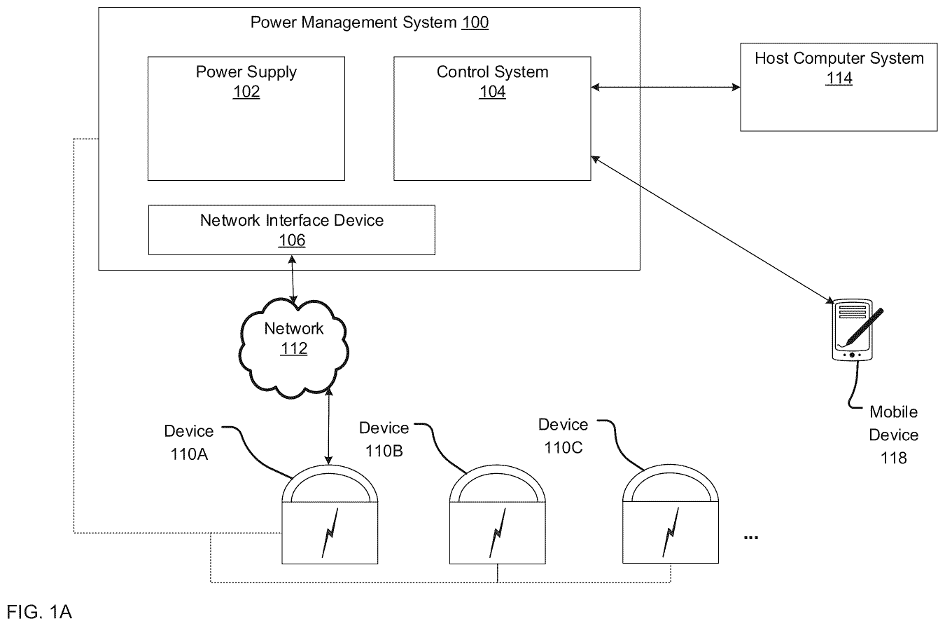

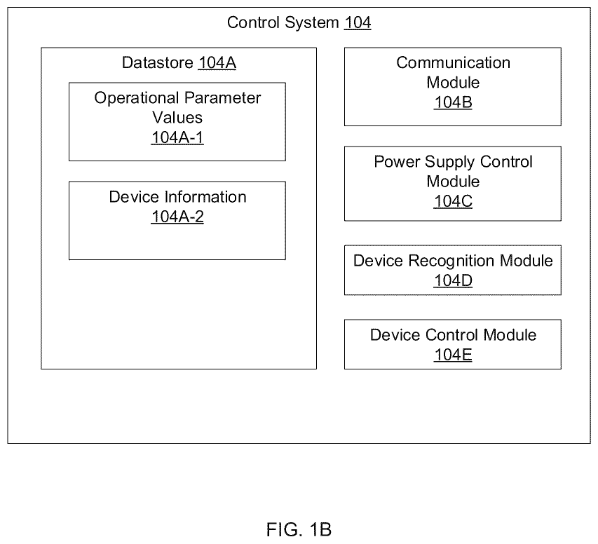

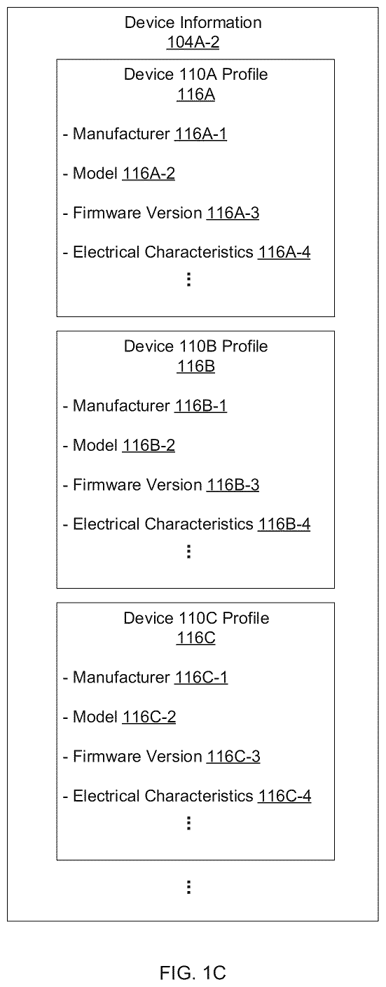

FIG. 1A is an example environment including a power management system 100, according to some embodiments of the technology described herein. As shown in FIG. 1A, the power management system 100 includes a power supply 102, a control system 104, and a network interface device 106. The power management system 100 may optimize its operation for devices 110A, 110B, 110C that are being powered by the power management system 100.

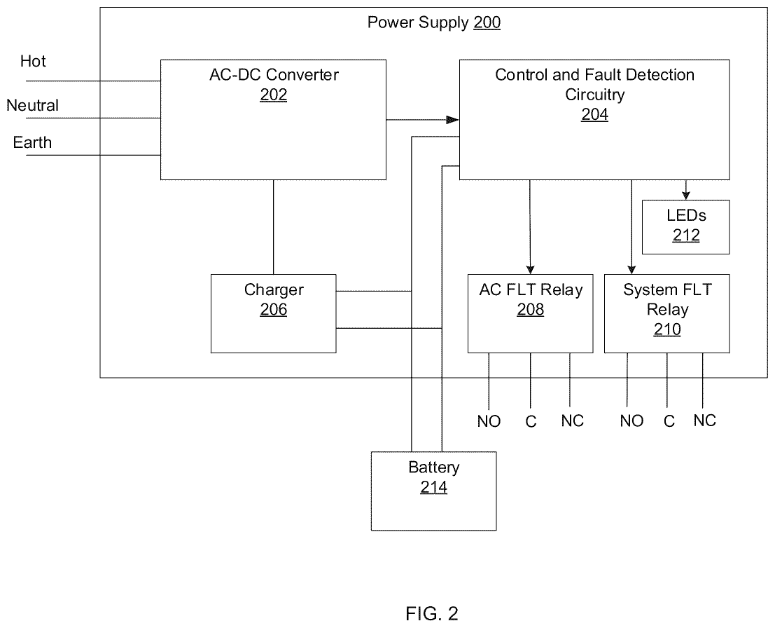

The power supply 102 may include various components for converting an alternating current (AC) electrical signal (e.g., received through a power line) to a direct current (DC) electrical signal. The power supply 102 may include output terminals through which the DC electrical signal can be outputted to devices. The power supply 102 may further include fault detection circuitry to detect faults in the power supply 102 (e.g., loss of an AC electrical signal). An example of power supply 102 that may be included in the power management system 100 is described herein with reference to FIG. 2.

As shown in FIG. 1A, the power supply 102 may supply power to devices 110A, 110B, 110C. For example, the power supply 102 may be connected to the devices 110A, 110B, 110C to provide the devices 110A, 110B, 110C with electrical power. In the example of FIG. 1A, the devices 110A, 110B, 110C are electronic locks that obtain electrical power from the power supply 102 of the power management system. In some embodiments, the devices 110A, 110B, 110C may each be a device other than an electronic lock. For example, the device may be a security camera, infrared sensor, and/or other electronic device. In some embodiments, one or more devices instead of or in addition to the devices 110A, 110B, 110C may obtain electrical power from the power supply 102.

The control system 104 may control operation of the power supply 102. The control system 104 may include a processor and memory. The memory may store operational parameters for controlling the power supply 102. The control system 104 may use the processor to perform various operations of the control system 104 described herein. Example components of the control system 104 are described herein with reference to FIG. 1B.

The control system 104 may control operation of the power supply 102 based on identities of the devices 110A, 110B, 110C. In some embodiments, the control system 104 may control operation of the power supply 102 by configuring one or more operational parameters stored in memory of the control system 104. The control system 104 may be configured the operational parameter(s) based on identities of devices that are powered by the power supply 102. For example, the control system 104 may configure the operational parameter(s) to optimize performance of the power supply 102 for the specific devices being powered by the power supply 102.

The control system 104 may determine an identity of a particular device. In some embodiments, the control system 104 may determine an identity of a particular device by obtaining authentication information from the device. For example, the control system 104 may obtain a digital certificate from the device. The control system 104 may use the digital certificate to determine an identity of the device. For example, the control system 104 may determine electrical characteristics of the device, a model number, serial number, manufacturer name, firmware version, manufacturing date, and/or other information identifying the device. The control system 104 may configure operational parameters for controlling the power supply 102 based on the identity of the device. In some embodiments, the control system 104 may access a device profile associated with the identity, and use the profile to configure operational parameters. For example, the device profile may indicate values of various operational parameters. The control system 104 may configure the operational parameter to values indicated by the device profile.

In some embodiments, the control system 104 may configure operational parameters based on an identity of a particular device to improve performance of the device. For example, the control system 104 may configure operation of the power supply 102 in the case of a fault or failure to prevent damage or failure of the device. As another example, the control system 104 may configure operation of the power supply 102 to improve efficiency of energy usage by the device. As another example, the control system 104 may configure operation of the power supply 102 to provide voltage to a device within a particular voltage range optimized for the device (e.g., in a safe operation range and/or in a voltage range that maximizes power efficiency of the device).

In some embodiments, the control system 104 may communicate with one or more of the devices 110A, 110B, 110C through a wired connection. A device may be connected to the power management system 100 through a cable. The control system 104 may communicate with the device through the cable. For example, the cable may be a power over ethernet (POE) cable (e.g., an IEEE 802.3 AA 4-wire PoE cable), a recommended standard (RS) cable (e.g., RS-485 AA 4-wire cable), a fiber optic power cable, or other suitable cable.

The network interface device 106 may allow the control system 104 to communicate with one or more of the devices 110A, 110B, 110C through a communication network 112. In some embodiments, the network interface device 106 may be a wireless hub through which the control system 104 can wirelessly communicate with one or more of the devices 110A, 110B, 110C. For example, the wireless hub may be a WiFi hub, a Zigbee hub, or another suitable wireless hub. In some embodiments, the control system 104 may communicate with other devices in addition to or instead of the devices 110A, 110B, 110C through the network interface device 106. As an illustrative example, the control system 104 may collect wirelessly connected sensor data from sensor(s) through the wireless hub. The control system 104 may use information from the sensor(s) to control operation of the power management system 100. For example, the control system 104 may adjust the power output of the power supply 102 based on the sensor information. As another example, the control system 104 may control a device based on sensor information. To illustrate, the control system 104 may automatically unlock an electronic lock device based on sensor information indicating an emergency situation (e.g., a fire) in which a first responder is attempting to access a location (e.g., a building). The control system 104 may automatically unlock the electronic lock device thereby not requiring the first responder to spend time obtaining an emergency key to unlock the electronic lock device.

In some embodiments, the network interface device 106 may be a network interface card (NIC) that may be used to communicate through network 112. The network interface device 106 may transmit packets to a device and receive packets from the device through network 112. For example, the network interface device 106 may be used by the control system 104 to obtain authentication information (e.g., a digital certificate) from a particular device through communication network 112.

In some embodiments, the network interface device 106 may form an encrypted connection with a device through network 112. The encrypted connection may prevent an adversary from obtaining information being exchanged between the network interface device 106 and the device. The network interface device 106 may exchange (e.g., send and receive) encrypted communications through the encrypted connection. For example, the network interface device 106 may use a transport layer security (TLS) 1.2 encryption. In some embodiments, the network interface device 106 may exchange heartbeat messages through the encrypted connection. The network interface device 106 may transmit a heartbeat message and receive a corresponding heart message in response. The heartbeat messages may indicate whether the device is still in communication.

Network 112 may be any suitable communication network. For example, network 112 may be a network of one or more devices in communication with a router (e.g., an IEEE 802.11 WiFi router). As another example, network 112 may be the Internet. As another example, network 112 may be a network of wired connections (e.g., RS-485 AA 4-wire connections, or IEEE 802.E power over ethernet (POE) connections). As another example, network 112 may be the Internet. As another example, network 112 may be a Bluetooth network.

In some embodiments, the control system 104 may control the devices 110A, 110B, 110C (e.g., through a wired or wireless connection with the device). The control system 104 may transmit control signals that trigger action by a device. For example, for an electronic lock device, the control system 104 may lock or unlock the device (e.g., in response to a signal from an emergency first responder system to enable access by a responder). As another example, the control system 104 may power cycle a device (e.g., to reset operation after the occurrence of an error).

The environment of FIG. 1A further includes a host computer system 114. The host system 114 may be any suitable computing device. The host computer system 114 may be in communication with the control system 104. The host computer system 114 may be used to configure the control system 104. For example, the host computer system 114 may be used to change the settings of the control system 104. The host computer system 114 may further be used to view information collected by control system 104. For example, the host system 114 may be used to access information about devices that control system 104 has identified. The host system 114 may further be used to view operational parameter values configured by the control system 104.

In some embodiments, the host system 114 may be used to provide information about devices to the control system 104. For example, the host system 114 may provide device profiles to the control system 104 for use in configuring the operation of the power supply 102 based on device identities. In some embodiments, the host system 114 may provide information for use by the control system 104 in configuring the power supply 102. For example, the host system 114 may provide energy management information about a device that the control system 104 may use to configure operational parameters to improve the energy efficiency of the device and/or to maintain power supplied to the device within an operational limit (e.g., voltage limit) of the device.

In some embodiments, the host system 114 may access information from one or more external sources. In some embodiments, the host system 114 may access information through the Internet. For example, the host system 114 may access energy cost information from energy providers. The host system 114 may use this information to determine energy costs of past operation of a device, expected future cost of operation of a device (e.g., predicted based on past device operation), and/or other information about the energy consumption of the device. As another example, the host system 114 may access weather information about the weather in a geographic area of the power management system 100. As another example, the host system 114 may aggregate device operation data. The host system 114 may combine data about the operation of the devices 110A, 110B, and 110C with data about the operation of other devices (e.g., collected by other power management systems). The host system 114 may provide insights using the aggregated data (e.g., regarding device operational efficiency, failures, and/or other information).

As shown in the embodiment of FIG. 1A, the control system 104 may communicate with a mobile device 118. The mobile device 118 may interact with the control system 104 through a mobile application. For example, the mobile application may be an Android or iOS application through which a user may interact with the control system 104. In some embodiments, the mobile device 118 may be used to configure and/or set up the control system 104. For example, the control system 104 may receive, from the mobile device 118, an indication of which devices to perform optimization for. As another example, the control system 104 may receive, through the control system 104, user input indicating specific types of optimizations to be applied to respective devices. As another example, the control system 104 may receive, from the mobile device 118, information about devices (e.g., for storage in device profiles).

FIG. 1B shows components of the control system 104 of the power management system of FIG. 1A, according to some embodiments of the technology described herein. As shown in FIG. 1B, the control system 104 includes a datastore 104A, a communication module 104B, a power supply control module 104C, a device recognition module 104D, and a device control module 104E.

The datastore 104A may comprise of memory of the control system 104. The memory may be any suitable memory. For example, the datastore 104A may include one or more hard drives. As another example, the control system 104 may be implemented on an integrated circuit or chip, and the datastore 104A may be a memory module in the integrated circuit or chip.

As shown in FIG. 1B, the datastore 104A stores operational parameter values 104A-1 for controlling the power supply 102. The operational parameter values 104A-1 may dictate the operation of the power supply 102. For example, the operational parameter values 104A-1 may determine how the control system 104 operates the power supply 102 in cases of a fault (e.g., loss of AC power, failure of the power supply 102, or another fault). As another example, the operational parameter values 104A-1 may determine the power outputted by the power supply 102 (e.g., a voltage range of the power output).

The datastore 104A stores device information 104A-2. The device information 104A-2 may include information about various devices. For example, the device information 104A-2 may include device profiles that can be used by the control system 104 to configure the operational parameter values 104A-1. The device information 104A-2 may include information about devices that have been identified (e.g. by the device recognition module 104D). For example, the device information 104A-2 may include electrical characteristics of the device, manufacture name, model number, firmware version of software installed on the device, and/or manufacturing date of an identified device (e.g., that is powered by the power management system 100).

FIG. 1C shows example device information 104A-2 that may be stored in a datastore of the control system of FIGS. 1A-1B, according to some embodiments of the technology described herein. As shown in FIG. 1C, the device information 104A-2 includes device profiles 116A, 116B, 116C for respective devices 110A, 110B, 110C. Each of the device profiles 116A, 116B, 116C stores information about a respective one of the devices 110A, 110B, 110C. In the example of FIG. 1C, the device profile 116A stores a manufacturer 116A-1, model 116A-2, firmware version 116A-3, and electrical characteristics 116A-4 for the device 110A. The device profile 116B stores a manufacturer 116B-1, model 116B-1 firmware version 116B-3, and electrical characteristics 116B-4 for the device 110B. The device profile 116C stores a manufacturer 116C-1, model 116C-2, firmware version 116C-3, and electrical characteristics 116C-4 for device 110C. In some embodiments, electrical characteristics for a particular device may include various types of information. For example, the electrical characteristics may include upper and lower power voltage limits of operation for the device (e.g., safety operation and/or proper functionality of the device). As another example, the electrical characteristics may include an indication of an optimal voltage operation range for device functionality (e.g., optimal device power efficiency, optimal computational efficiency, and/or other performance).

In some embodiments, the device profiles 116A, 116B, 116C may be pre-loaded into the datastore 104A of the control system 104. For example, the device profiles 116A, 116B, 116C may be pre-loaded during manufacturing of the control system 104. In some embodiments, the device profiles 116A, 116B, 116C may be loaded into the datastore 104A by another device. For example, the host computer system 114 may be used to load the device profiles 116A, 116B, 116C into the datastore 104A of the control system 104. As another example, the control system 104 may interact with a mobile device through a mobile application. The control system 104 may be loaded with the device profiles 116A, 116B, 116C through the mobile application (e.g., in response to use input specifying devices 110A, 110B, 110C to be optimized by the control system 104). In some embodiments, the control system 104 may automatically acquire the device profiles 116A, 116B, 116C. For example, the control system 104 may: (1) identify the devices 110A, 110B, 110C; and (2) access the device profiles 116A, 116B, 116C from a repository (e.g., Internet repository) based on identities of the devices 110A, 110B, 110C.

Returning again to FIG. 1B, the communication module 104B may manage communication with devices. The communication module 104B may use the network interface device 106 of the power management system 100 to communicate with the devices 110A, 110B, 110C through the network 112. For example, the communication module 104B may use the network interface device 106 to establish an encrypted connection with a particular device.

The communication module 104B may exchange information with the devices 110A, 110B, 110C. In some embodiments, the communication module 104B may obtain authentication information from a particular device. For example, the communication module 104B may obtain a digital certificate from a chipset of the device. In some embodiments, the communication module 104B may send authentication information to a device. For example, the communication module 104B may transmit a digital certificate authenticating the control system 104 to a device.

In some embodiments, the communication module 104B may allow communication with a device using a standard. For example, the communication module 104B may allow communication with the device using the Open Supervised Device Protocol (OSDP). The communication module 104B may embed a command data structure into an OSDP protocol communication that allows communication with the device. For example, the communication module 104B may access information from the device through the command structure and/or transmit control signals to the device in the command structure. The communication module 104B may use the command structure to identify the device.

In some embodiments, the communication module 104B may aggregate information from other systems. For example, the communication module 104B may aggregate information about other devices of a model from a central repository accessible by the communication module 104B (e.g., through the Internet). As another example, the communication module 104B may obtain weather information (e.g., temperature, humidity, windspeed, and/or other information) about an environment of the system 100. As another example, the communication module 104B may obtain energy cost information (e.g., from an energy provider computer system). As another example, the communication module 104B may obtain information about power availability (e.g., whether there is a blackout or brown out). Information aggregated by the communication module 104B may be used by the power supply control module 104C and/or the device control module 104E in performing control operations.

In some embodiments, the communication module 104B may obtain data from one or more sensors. For example, the power management system 100 may include one or more environment sensors (e.g., temperature sensor(s), humidity sensor(s), and/or other suitable sensor(s)). The communication module 104B may receive information from the sensor(s). For example, the communication module 104B may wirelessly receive information from the sensor(s). The information from the sensor(s) may be used by the power supply control module 104B and/or the device control module 104E in performing control.

The power supply control module 104C may configure operation of the power supply 102. In some embodiments, the power supply control module 104C may configure operation of the power supply 102 by configuring the operational parameter values 104A-1 stored in the datastore 104A of the control system 104. The power supply control module 104C may use a device identity to control operation of the power supply 102. For example, the power supply control module 104C may set operational parameter values based on a device identity (e.g., by accessing a profile specifying values associated with the device identity).

The power supply control module 104C may control operation of the power supply 102 based on various conditions. The conditions may include fault conditions, failure conditions, and/or other conditions. The power supply control module 104C may: (1) detect occurrence of a condition; and (2) control operation of the power supply 102 based on the detected condition. For example, the power supply control module 104C may detect a loss of AC power fault, and modify operation of the power supply 102 in response to detecting the loss of AC power. As another example, the power supply control module 104C may: (1) detect a failure in the power supply 102; and (2) modify operation of the power supply 102 in response to detecting the failure. The power supply control module 104C may control the operation of the power supply 102 in response to detection of a condition based on identities of the devices 110A, 110B, 110C. For example, the power supply control module 104C may modify operation of the power supply 102 in a manner that is optimized for the devices 110A, 110B, 110C.

In some embodiments, the power supply control module 104C may control operation of the power supply 102 by modulating power provided to a device (e.g., one of devices 110A, 110B, 110C). For example, a device profile may store a voltage range of operation for the device (e.g., for safety or efficiency). The power supply control module 104C may modulate power provided to the device from the power supply 102 such that voltage provided to the device is within the voltage range of operation (e.g., to ensure safety and/or efficiency of the device). For example, the power supply control module 104C may dynamically control a power output of the power supply 102 such that the voltage output remains in the voltage range. As another example, the power supply control module 104C may control a duty cycle of power being supplied to a device based on information about the device in the device profile. As another example, the power supply control module 104C may cause the power supply 102 to ender a standby state to protect devices (e.g., in the case of a power black out or brown out).

The device recognition module 104D may determine an identity of a device. The device recognition module 104D may determine an identity of a device using authentication information obtained from the device. For example, the device recognition module 104D may determine an identity of a device using a digital certificate obtained from a chipset of the device. For example, the device recognition module 104D may determine a manufacturer name, model number, firmware version, and/or manufacturing date of the device. The device recognition module 104D may determine an identity of a device using a digital certificate obtained from the device by: (1) identifying information indicating an identity of the device in the digital certificate (e.g., an encrypted key or other information); and (2) determining the identity of the device using the information.

In some embodiments, a digital certificate for a device may be loaded into the device by a manufacturer of the device. The digital certificate may enable interaction of the device with the control system 104. In some embodiments, a device may be loaded with software (e.g., in firmware of the device) that allows the device to interact with the control system 104. For example, the device may be loaded with the software during manufacturing such that the device can be accessed by the control system 104 once deployed for use. The software may allow the device to be setup for optimization performed by the control system 104 (e.g., through a setup process performed by a user through a mobile device and/or host system).

In some embodiments, the device control module 104E may control operation of the devices 110A, 110B, 110C. The device control module 104E may be configurable to control various aspects of the devices 110A, 110B, 110C. In some embodiments, the device control module 104E may control a power switch of a device. The device control module 104E may thus power cycle the device. For example, the device control module 104E may power cycle a device to reset its operation (e.g., due to an error in device operation). To illustrate, the device control module 104E may power cycle a security camera that had stopped operation due to an error. In some embodiments, the device control module 104E may cause a device to perform an action. The device control module 104E may transmit a control signal (e.g., a command) that causes the device to perform an action. For example, for an electronic lock device, the device control module 104E may be configured to transmit a control signal to lock and/or unlock the device. To illustrate, the device control module 104E may be configured to unlock the device in response to a signal from a first responder (e.g., police system, fire station system, ambulance system, or other first responder system) that provides a first responder (e.g., police, firefighter, medic, or other first responder) access to a property (e.g., without having to spend time accessing an emergency key box).

In some embodiments, control of a device performed by the device control module 104E may be configurable (e.g., through the host system 114 and/or the mobile device 118). The device control module 104E may have control functionality enabled and/or disabled based on input received through the host system 114 and/or mobile device 118. For example, the control of the device may be configured based in input received through a graphical user interface (GUI) of a mobile device application executed by the mobile device 118.

FIG. 2 is an example power supply 200, according to some embodiments of the technology described herein. The power supply 200 may be used as the power supply 102 of the power management system 100 described herein with reference to FIGS. 1A-1B. The power supply 200 may be electrically coupled to devices (e.g., devices 110A, 110B, 110C of FIG. 1A).

The power supply 200 includes an isolated AC-DC converter 202. The AC-DC converter 202 may convert AC power into isolated DC power outputs (e.g., 12 V and/or 24 V outputs). The DC output from the AC-DC converter 202 may be sent to one or more output terminals.

The power supply 200 includes control and fault detection circuitry 204 may control the output terminals on which DC electrical signals are output by the AC-DC converter 202. The control and fault detection circuitry 204 may detect faults in the system such as loss of AC power, output voltage out of range vaults, and/or battery not present.

The circuitry 204 may manage battery power transfer in an event of an AC power loss. The charger 206 may charge the battery 214 and maintain it at near full capacity when AC power is available. The system fault relay 210 and the AC fault relay 208 may be energized when there is no fault condition present. When AC power is lost, the AC fault relay 208 may be de-energized resulting in a change in the contact state (e.g., closing or opening output contacts). The output contacts may be used by a control system (e.g., control system 104) to detect a fault condition. The LEDs 212 may indicate presence of an AC input, a DC output, a fault condition, and/or statuses (e.g., of a fire alarm interface (FAI) signal, and/or a battery).

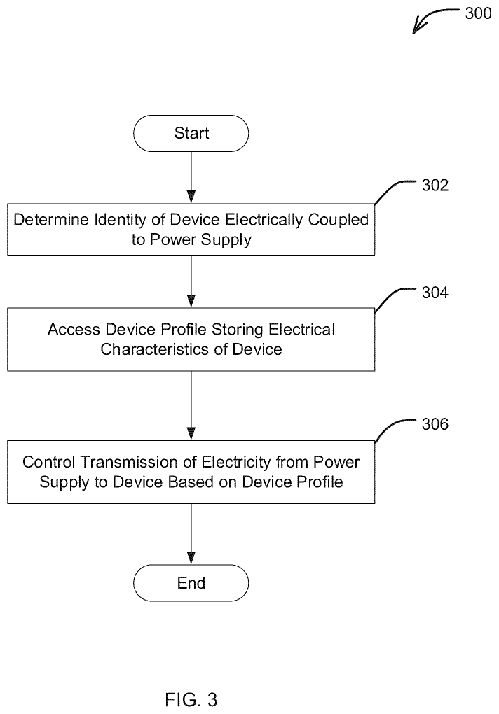

FIG. 3 is an example process 300 for configuring a power supply using an identity of a device, according to some embodiments of the technology described herein. Process 300 may be performed by the power management system 100 described herein with reference to FIGS. 1A-1B.

Next, process 300 proceeds to block 302, where the system obtains authentication information from the device. The system may obtain the authentication information through the connection. For example, the system may receive an encrypted digital certificate provided by the device. The system may decrypt the digital certificate. For example, the system may have a key that the system uses to decrypt the digital certificate. In some embodiments, the system may communicate with the device using the ODSP protocol to access the authentication information. In some embodiments, the system may establish an encrypted connection with the device (e.g., in which communications are encrypted using TLS 1.2 AES-128 encryption). The system may exchange information with the device through the encrypted connection. The system may receive the authentication information through the encrypted connection.

Next, process 300 proceeds to block 304, where the system accesses a device profile storing electrical characteristics of the device (e.g., device profile 116A described herein with reference to FIG. 1C). In some embodiments, the system may determine an identity of the device the using the authentication information and access the device profile using the determined identity. The device profile may indicate information about the device in addition to the electrical characteristics such as a manufacturer, model number, firmware version.

In some embodiments, the system may access the device profile from a datastore of the system. For example, the system may access the device profile from memory of the system. In some embodiments, the system may access the device profile from an external device or system. For example, the system may access, through a communication network (e.g., the Internet), the device profile.

Next, process 300 proceeds to block 306, where the system controls the transmission of electricity from a power supply to the device based on the device profile, configures a power supply using the determined identity of the device. In some embodiments, the system may control the transmission of electricity from the power supply to the device by modulating power provided by the power supply to the device. To illustrate, the system may module a voltage provided by the power supply to be within a particular voltage range (e.g., for safety and/or efficiency of the device) indicated by the device profile. As another example, the system may use information from the device profile to determine whether the device operates with a continuous duty cycle or an intermittent duty cycle, and control power according to the duty cycle of the device. As another example, the system may control the supply of power by automatically stopping power output to the device (e.g., to protect the device during a black out or brown out) in response to detecting certain conditions (e.g., a black out or brown out). As another example, the system may control transmission of electricity from the power supply to the device by cycling power of the device (e.g., to reset operation of the device).

In some embodiments, the system may use information from one or more sensors and/or external sources to control operation of the device. For example, the system may control transmission of electricity from the power supply to the device based on weather conditions (e.g., temperature, humidity, windspeed, and/or other conditions) indicated by sensor(s) and/or information from external sources. The system may optimize transmission of electricity based on the weather conditions. In some embodiments, the system may use data aggregated from multiple devices to determine device optimizations. The system may control the transmission of electricity to the device based on the optimizations.

In some embodiments, the system may control the transmission of electricity from the power supply to the device by configuring one or more operational parameters. For example, the system may configure operational parameter(s) that control an output voltage provided to the device from the power supply. As another example, the system may configure operational parameter(s) that determine operation of the power supply in fault conditions. In some embodiments, the system may control operational parameters of the power supply during operation of the device (e.g., in real time).

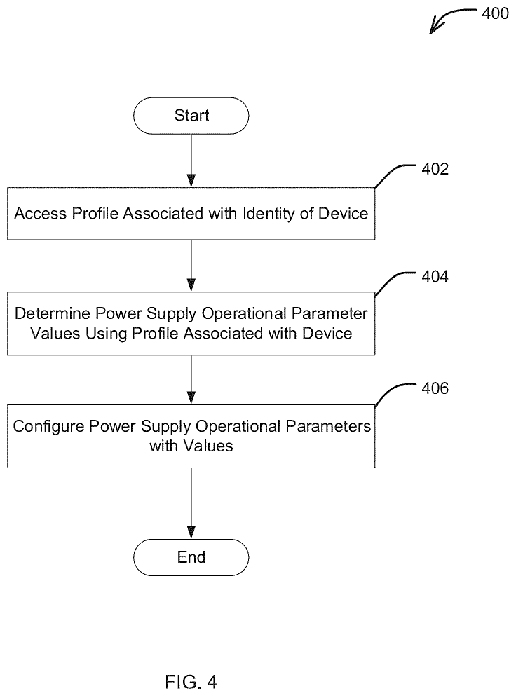

FIG. 4 is an example process 400 for configuring operational parameters of a power supply using a device identity, according to some embodiments of the technology described herein. Process 400 may be performed by power management system 100 described herein with reference to FIGS. 1A-1B. In some embodiments, process 400 may be performed at block 306 of process 300 described herein with reference to FIG. 3.

Process 400 begins at block 402, where the system access a profile associated with an identity of a device. For example, the profile may indicate a manufacturer name, model number, firmware version, manufacturing date of the device, and/or electrical characteristics of the device. In some embodiments, the system may access the profile from a datastore of the system storing profiles associated with various different devices. The system may select the profile from among the profiles based on the identity of the device (e.g., determined by performing process 300).

Next, process 400 proceeds to block 404, where the system determines power supply operational parameter values associated with the device using the profile. In some embodiments, the profile may indicate values (e.g., voltage range limits) of one or more operational parameters. The system may determine the operational parameter values to be those indicated by the profile. The system may execute the function(s) to determine the operational parameter values. In some embodiments, the profile may indicate one or more values (e.g., voltage output range values) that may be used by the system to determine the operational parameter values. For example, value(s) specified by the profile may be used as input to determine operational parameter values.

Next, process 400 proceeds to block 406, where the system configures the power supply operational parameters with the values determined at block 404. In some embodiments, the system may set the values in a software application. In some embodiments, the system may configure hardware (e.g., switches) in the power supply based on the operational parameter values.

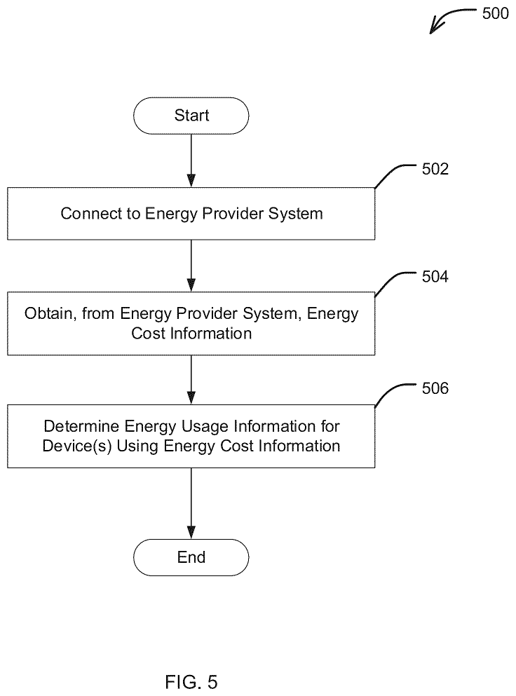

FIG. 5 is an example process 500 of optimizing energy management for a device, according to some embodiments of the technology described herein. Process 500 may be performed by power management system 100 described herein with reference to FIGS. 1A-1B. In some embodiments, process 500 may be performed to determine operational parameter values for a power supply.

Process 500 begins at block 502, where the system connects to an energy provider system. For example, the system may connect through a communication network (e.g., the Internet) to a computer system of an electric company.

Next, process 500 proceeds to block 504, where the system obtains, from the energy provider system, energy cost information. In some embodiments, the energy cost information may include a cost per unit of power (e.g., cost per kilowatt hour (kWh)). In some embodiments, the energy cost information may include a projected energy cost in a future time period. For example, the energy cost information may include a cost per unit of power in the next 1-4 months, 4-8 months, 8-12 months, 1-2 years, 3-4 years, 4-5 years, 5-10 years, or another suitable time period. In some embodiments, the energy cost information may include past energy costs. For example, the energy cost information may include a cost per unit of power in the previous 1-4 months, 4-8 months, 8-12 months, 1-2 years, 3-4 years, 4-5 years, 5-10 years, or another suitable time period.

Next, process 500 proceeds to block 506, where the system determines energy usage information for one or more devices (e.g., devices 110A, 110B, 110C) using the energy cost information. In some embodiments, the system may determine a cost of energy used by a given device during a time period. For example, the system may: (1) determine a cost of energy (e.g., price per kWh) during the time period indicated by the energy cost information; (2) determine an amount of power utilized by the device in the time period; and (3) determine the cost of energy using the used by the device in the time period using the cost of energy and the utilized amount of power (e.g., by multiplying kWh used by the price per kWh in the time period).

In some embodiments, the system may determine a predicted cost of energy usage by a given device in a future time period. The system may use a current energy cost and/or predicted future energy cost to determine the predicted cost of energy usage by the given device. The system may predict an amount of power the device is expected to use in the future time period. For example, the system may use an amount of power used by the device in the past as an indicator of expected future power consumption, and use the expected future power consumption in conjunction with the current energy cost and/or predicted future energy cost to determine the predicted cost of energy usage by the device.

In some embodiments, the system may provide the determined energy usage information to a user. For example, the system may generate a visualization of the energy usage information (e.g., past and/or predicted future energy costs for a device) in a graphical user interface (GUI) (e.g., in a mobile application of mobile device 118, on the host computer system 114, and/or in an Internet website).

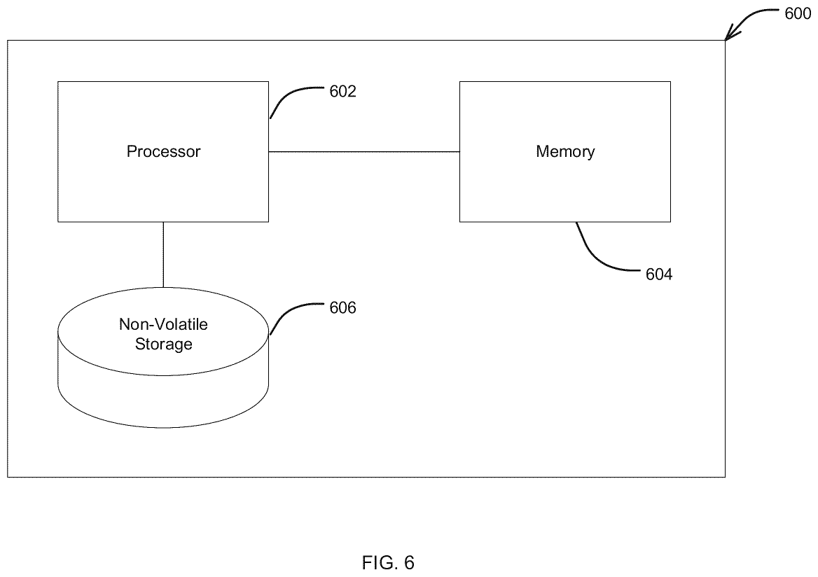

FIG. 6 is an example computer system that may be used to implement some embodiments of the technology described herein. The computing device 600 may include one or more computer hardware processors 602 and non-transitory computer-readable storage media (e.g., memory 604 and one or more non-volatile storage devices 606). The processor(s) 602 may control writing data to and reading data from (1) the memory 604; and (2) the non-volatile storage device(s) 606. To perform any of the functionality described herein, the processor(s) 602 may execute one or more processor-executable instructions stored in one or more non-transitory computer-readable storage media (e.g., the memory 604), which may serve as non-transitory computer-readable storage media storing processor-executable instructions for execution by the processor(s) 602.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A power management system that customizes operation for devices being powered by the power management system, the system comprising:
a power supply electrically coupled to at least one device, the at least one device including a first device;
a control system configured to control operation of the power supply, the control system comprising:
a processor; and
a memory configured to store a first device profile storing electrical characteristics of the first device;
wherein the control system is configured to use the processor to:
determine an identity of the first device electrically coupled to the power supply;
access, from the memory, the first device profile storing electrical characteristics of the first device; and
control transmission of electricity from the power supply to the first device based on the electrical characteristics of the first device.

2. The system of claim 1, wherein controlling the transmission of electricity from the power supply to the first device based on the electrical characteristics of the first device comprises:
modulating a voltage output to the first device.

3. The system of claim 2, wherein,
the electrical characteristics of the first device comprises a voltage range of operation for the first device, and
modulating the voltage output to the first device comprises modulating the voltage to remain within the voltage range of operation.

4. The system of claim 1, wherein the device profile further stores one or more of an identifier of a manufacturer of the first device, a model of the first device, and a firmware version of software installed on the first device.

5. The system of claim 1, further comprising:
a wireless communication device;
wherein the control system is configured to use the processor to:
communicate with at least one sensor using the wireless communication device; and
control transmission of electricity from the power supply to the first device based on information obtained from the at least one sensor.

6. The system of claim 1, in combination with the first device, wherein the first device is an electronic lock.

7. The system of claim 1, in combination with the first device, wherein:
the first device includes a chipset; and
determining the identity of the first device comprises obtaining authentication information from the chipset of the first device.

8. The system of claim 7, wherein the authentication information obtained from the first device comprises a digital certificate provided by the first device.

9. The system of claim 1, wherein:
the at least one device includes a second device different from the first device;
the memory is configured to store a second device profile storing electrical characteristics of the second device; and
the control system is configured to use the processor to:
determine an identity of the second device electrically coupled to the power supply;
access, from the memory, the second device profile storing electrical characteristics of the second device; and
control transmission of electricity from the power supply to the second device based on the electrical characteristics of the second device.

10. The system of claim 1, wherein the control system is further configured to use the processor to:
access, from a computer system associated with an energy provider, energy cost information; and
determine an energy cost of operating the first device during a time period.

11. A method of customizing operation of a power management system for devices being powered by the power management system, the power management system comprising a power supply electrically coupled to at least one device, the method comprising:
using a processor to perform
determining an identity of a first device of the at least one device electrically coupled to the power supply;
accessing, from memory of the power management system, a first device profile storing electrical characteristics of the first device; and
controlling transmission of electricity from the power supply to the first device based on the electrical characteristics of the first device.

12. The method of claim 11, wherein controlling the transmission of electricity from the power supply to the first device based on the electrical characteristics of the first device comprises:
modulating a voltage output to the first device.

13. The method of claim 12, wherein,
the electrical characteristics of the first device comprises a voltage range of operation for the first device, and
modulating the voltage output to the first device comprises modulating the voltage to remain within the voltage range of operation.

14. The method of claim 11, wherein the device profile further stores one or more of an identifier of a manufacturer of the first device, a model of the first device, and a firmware version of software installed on the first device.

15. The method of claim 11, further comprising:
communicating, using a wireless communication device, with at least one sensor; and
controlling transmission of electricity from the power supply to the first device based on information obtained from the at least one sensor.

16. The method of claim 11, wherein the first device is an electronic lock.

17. The method of claim 11, wherein:
the first device includes a chipset; and
determining the identity of the first device comprises obtaining authentication information from the chipset of the first device.

18. The method of claim 17, wherein the authentication information obtained from the first device comprises a digital certificate provided by the first device.

19. The method of claim 11, wherein the at least one device includes a second device different from the first device and the method further comprises:
determining an identity of the second device electrically coupled to the power supply;
accessing, from the memory, a second device profile storing electrical characteristics of the second device; and
controlling transmission of electricity from the power supply to the second device based on the electrical characteristics of the second device.

20. A non-transitory computer-readable medium storing instructions that, when executed by a processor, cause the processor to perform a method of customizing operation of a power management system for devices being powered by the power management system, the power management system comprising a power supply electrically coupled to at least one device, the method comprising:
determining an identity of a first device of the at least one device electrically coupled to the power supply;
accessing, from memory of the power management system, a first device profile storing electrical characteristics of the first device; and
controlling transmission of electricity from the power supply to the first device based on the electrical characteristics of the first device.
